(19) United States
(12) Patent Application Publication
(10) Pub. No.: US 2011/0038693 A1
(43) Pub. Date: Feb. 17, 2011

(54) SLUICE DEVICE AND METHOD FOR OPENING THE SLUICE DEVICE

(76) Inventors: Holger Behrens, Erkrath (DE); Ralf-Hartmut Sohl, Solingen (DE); Lutz Kuemmel, Juechen (DE)

Correspondence Address: ABELMAN, FRAYNE & SCHWAB, 666 THIRD AVENUE, 10TH FLOOR, NEW YORK, NY, 10017, US

(21) Appl. No.: 12/734,184

(22) PCT Filed: Oct. 11, 2008
(86) PCT No.: PCT/EP2008/010773

§ 371 Date: Aug. 4, 2010

(30) Foreign Application Priority Data
Oct. 17, 2007 (DE) 10 2007 049 669.0

(51) Int. Cl. B65G 49/00

(52) U.S. Cl. 414/217; 414/805

(57) ABSTRACT

The invention relates to a sluice device (10, 10′) with at least one individual sluice (11) for the passing of strip material (2).

In order to also be able to maintain or repair the sluice device and in particular its individual sluices, without the strip material (2) having to be removed from the sluice device, it is proposed according to the invention that the individual sluice is formed from at least a first and a second part, in which the two parts are connected with each other via a releasable connection for opening and closing the individual sluice and that at least one device (24, 25) is provided for displacing or moving the first and the second part of the individual sluice relative to each other in or contrary to the transportation direction of the strip material (2) with the connection opened.

### TECHNICAL FIELD

The invention relates to a sluice device in particular for endless strip material running into and/or out from a process area, in accordance with the introductory clause of Claim 1. The invention further relates to a method for opening the sluice device.

### PRIOR ART

In the production and processing of strip material, in particular of metal strips in various closed-off spatial areas provided for this, known sluice devices are used which separate the spatial areas from each other but nevertheless allow a transportation of the strip material into or out from a spatial area. Different process conditions can prevail in the spatial areas, such as for example different pressure conditions. Thus, for example, a vacuum can prevail in one spatial area and/or in another spatial area normal pressure or a systematic protective gas atmosphere or excess pressure can be present.

From the older, not previously published application DE 10 2006 051 397 of the applicant, a strip sluice is known which uses rollers for sealing between two spatial areas. Also, from the not previously published application DE 10 2006 051 395 of the applicant, a strip sluice is known which uses shutter elements as sealing means between two spaces.

DE 60 2004 001 403 T2 discloses a sealing sluice for a chamber for the vacuum coating of a strip, in which a housing is provided with an upper cover and a lower cover, with rollers being mounted on the upper cover and on the lower cover, which rollers are staggered relative to each other in the strip direction and are acted upon against the strip, in order to transport the latter, with an underpressure chamber being respectively delimited between two pairs of rollers respectively.

These sluice devices from the prior art have the disadvantage that in the case of maintenance and repair, the sluice devices have to be dismantled with great effort, for example with a lifting crane, and that in this case the strip material can not remain unchanged in the sluice, because otherwise the lower and the upper housing covers can either not be separated or, for example, are not easily accessible for maintenance purposes.

A sluice device according to the prior art therefore requires a very laborious handling of the sluice device and of the endless metal strip which is passed through.

### DESCRIPTION OF THE INVENTION, OBJECT, SOLUTION, ADVANTAGES

It is the object of the present invention to provide a sluice device which is easily accessible in the use or processing in particular of endless strip material in particular in the case of maintenance or repair, with the strip material also being able to remain in the sluice device in the case of maintenance or repair. The object further consists in providing a method for the maintenance of a corresponding sluice device.

The problem is solved according to the invention by the subject matter of Claim 1. Accordingly, the sluice device is characterized in that at least one of its individual sluices is formed from at least a first and a second part; that a releasable connection is provided between the first and the second part for opening and closing the individual sluice; and that at least one device is provided for displacing the first and second parts of the individual sluice relative to each other in or contrary to the transportation direction of the strip material when the connection is opened.

By the claimed moving apart of the two parts along the strip material, the interior of the individual sluice is accessible over a large area, for example for maintenance work, whilst at the same time the strip material does not have to be removed.

According to a first example embodiment of the invention, the connection in the form of a fastening means is arranged in the transition between a lateral wall and the housing casing. The first part of the individual sluice then consists of the one lateral wall whilst the second part of the individual sluice comprises the housing casing and the second lateral wall.

When the individual sluice has processing- or transportation means and drives for these means, which are either fastened on one of the lateral walls or on the housing casing, this has the advantage that they are associated with the first or the second part of the individual sluice and can be moved together with these respective parts.

An external pipe connection is usually connected to the individual sluices for setting a desired process condition, for example a particular pressure ratio within the individual sluice. Basically, it is then advantageous if the pipe connection can also be moved either together with the first or the second part of the individual sluice to which it is connected. Alternatively, it is advantageous if the pipe connection can be initially detached from the corresponding part of the individual sluice before this part is moved.

For a moving of the first part and of the second part of the individual sluice relative to each other it is basically sufficient if one of the two parts of the individual sluice is mobile by means of a device for displacement. The other part of the individual sluice can then either be stationary, for example mounted securely to the process area, or it is likewise able to be moved by means of a further device for displacement.

The device for displacement can either be constructed as a movable undercarriage or as a sliding arrangement.

In the case where the sluice device is constructed as a sluice cascade with a plurality of individual sluices connected in series, at least one of these individual sluices is to be constructed in two parts in line with the invention with a first and a second part which are detachable from each other. The further individual sluices of the sluice cascade are then connected to the first or the second part of the two-part individual sluice and are associated accordingly with the first or second part and are movable together therewith.

In the case of two adjacent individual sluices, it is advantageous if these two individual sluices, in their transition region to each other, do not have respectively a separate lateral wall, but rather, instead have a shared lateral wall with a sluice opening for a transition or passage of the sluice material from the one individual sluice into the other.

The above-mentioned object of the invention is further solved by a method for opening a sluice device according to the invention. The advantages of this method are in accordance with the advantages mentioned above with reference to the sluice device.

Further advantageous developments of the sluice device and of the method are the subject matter of the dependent claims.

A total of 6 figures are enclosed with the description, in which

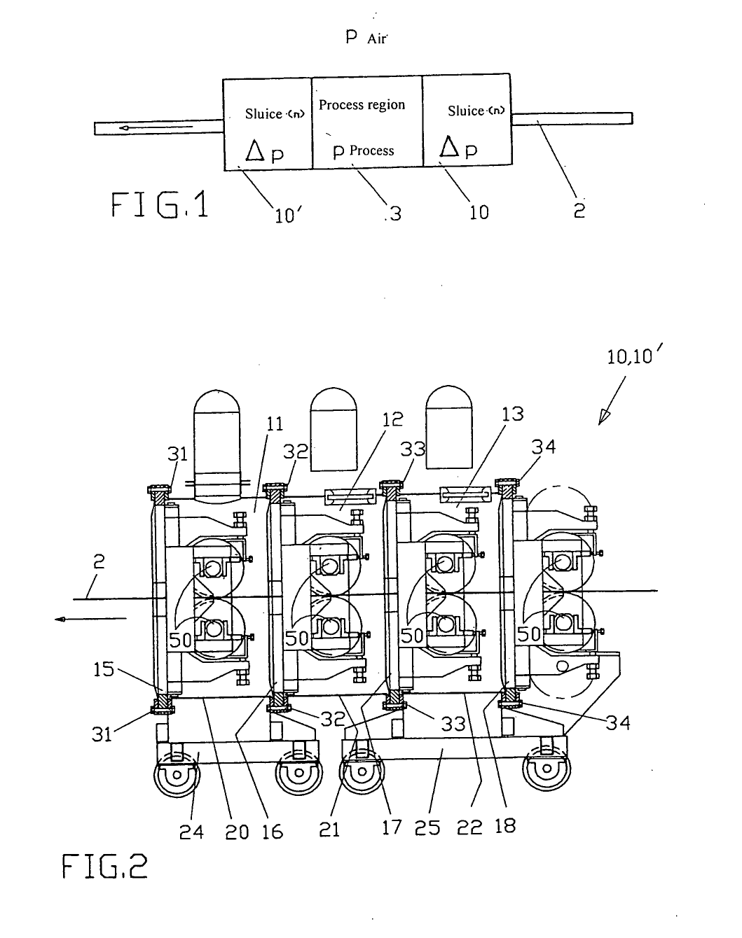

FIG. 1 shows an application of the sluice device according to the invention;

FIG. 2 shows the sluice device according to the invention in the form of a sluice cascade with three individual sluices connected in series, in the closed state;

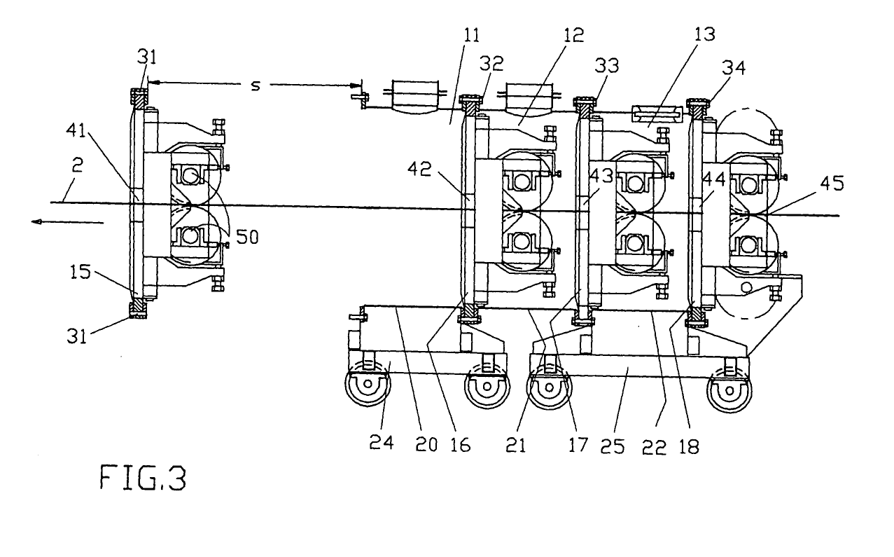

FIG. 3 shows the sluice device according to the invention with three individual sluices in which, however, the first individual sluice is open;

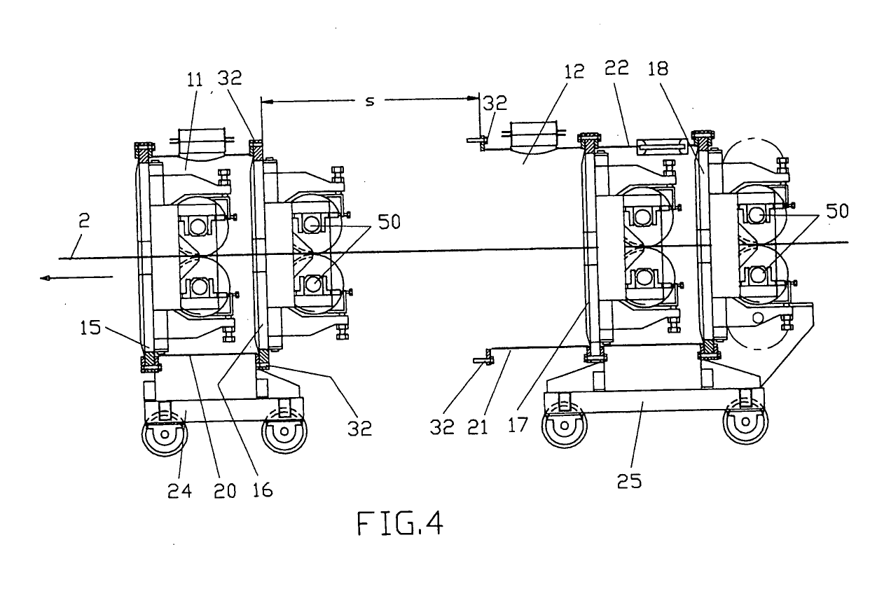

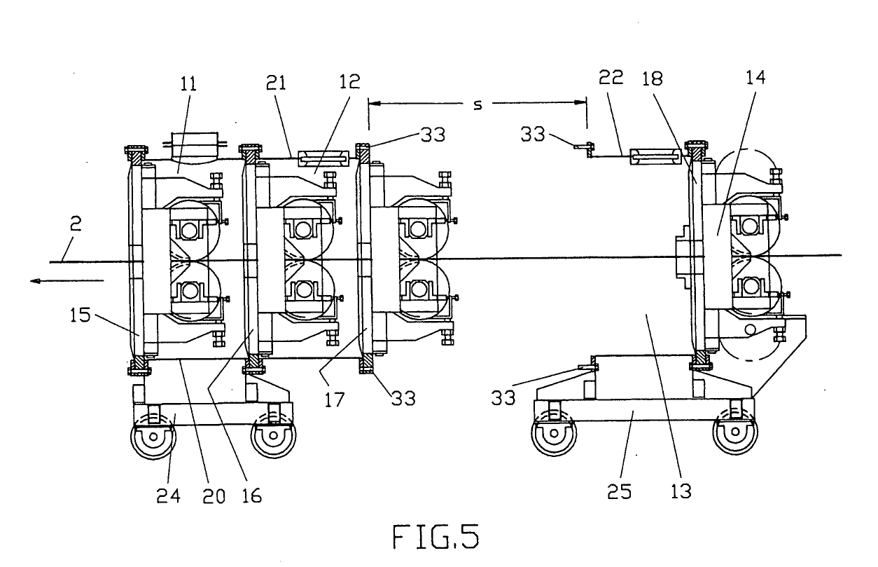

FIG. 4 shows the sluice device according to the invention with three individual sluices in which, however, the second individual sluice is open;

FIG. 5 shows the sluice device according to the invention with the three individual sluices in which, however, the third individual sluice is open; and

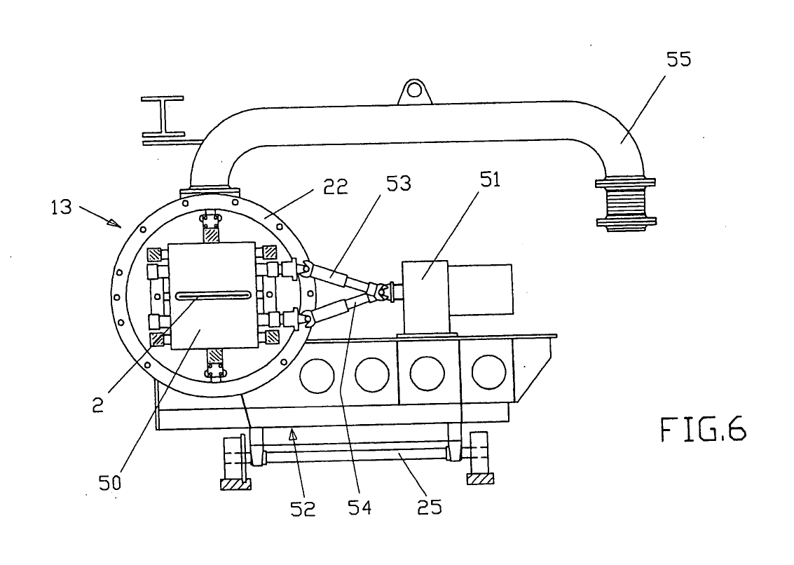

FIG. 6 shows a cross-section through an individual sluice in a plane transverse to the transportation direction of the strip material.

The invention is described in detail below with the aid of example embodiments with reference to the named figures.

FIG. 1 shows a process area 3 as a closed-off spatial area in which strip material is processed under predetermined process conditions p_{Process}. The process conditions may, for example, be a specifically set pressure, for example an underpressure. Compared with this, basically atmospheric pressure p_{Air} prevails outside the process area 3. Before the strip material 2 enters into the actual process area 3, it is firstly directed through a first sluice device 10. In an analogous manner, the strip material, after processing in the process area 3, is directed through a second sluice device 10′, before it is again exposed to the atmospheric conditions. In the two sluice devices 10, 10′, respectively a pressure difference □p is ensured between the process condition in the process area 3 and the outer atmospheric pressure p_{Air}. As the strip material 2 is guided in or respectively out through the two sluice devices 10, 10′ into the process area 3, the predetermined process conditions can be maintained in the process area 3.

FIG. 2 shows one of the sluice devices 10, 10′ according to the present invention. The sluice device 10, 10′ consists of a plurality of individual sluices 11, 12, 13, in which in the example embodiment according to FIG. 2, three individual sluices 11, 12, 13 without the restriction of commonality are illustrated. In practice, more or fewer individual sluices can also be present; however, at least two individual sluices, connected in series, are required before, and at least two individual sluices, connected in series, are required after the actual process area 3 according to FIG. 3. Each of the individual sluices 11, 12, 13 is formed and delimited by respectively two lateral walls 15, 16, 17, 18 and a housing casing 20, 21, 22 connecting the walls. According to the invention, the housing casings 20, 21, 22 are advantageously constructed as encircling in one part or in several parts.

In the example embodiment according to FIG. 2, the housing casings are fastened releasably on the respectively laterally adjacent walls 15, 16, 17, 18 by connections 31, 32, 33, 34 in the form of fastening means. With a closed connection, the housing casings are carried via these connections by the lateral walls.

Finally in FIG. 2, transportation- or processing rollers 50 can be seen for transporting or processing the strip material 2. These rollers are fastened for example respectively on a lateral wall 15, 16, 17, 18.

The strip material 2 is transported in FIG. 2 in the arrow direction.

In FIG. 3 it can be seen that the connection 31 of the first individual sluice 11 is open at the transition between the lateral wall 15 and the housing casing 20.

In this case, the lateral wall 15 forms, together with the transportation- or processing rollers 50 fastened on it, a first part of the first individual sluice 11. This first part can be mounted for example at the process area 3 adjoining on the left, i.e. in the transportation direction of the strip 2, and can be carried by it. In contrast, the housing casing 20, together with the right-hand lateral wall 16, forms a second part of the first individual sluice 11. The further individual sluices 12 and 13 respectively with their transportation- and processing rollers 5, are associated with this second part. According to the example embodiment shown in FIG. 3, the second part of the first individual sluice 11 and the further individual sluices 12 and 13 connected securely therewith are movable by means of devices 24, 25 for displacement laterally in or contrary to the transportation direction of the strip material 2; the transportation direction of the strip is also marked by an arrow towards the left in FIG. 3.

In FIG. 3, the second part is moved with the associated further individual sluices 12 and 13 by the distance S with respect to the fixedly arranged first part of the individual sluice 12 contrary to the transportation direction of the strip. By the separation of the two individual parts, the individual sluice 11 is open and its interior and in particular the transportation- and processing rollers 50 are thus easily accessible in particular for maintenance purposes. The strip material 2 is guided through sluice openings 41, 42, 43, 44, 45 in each of the lateral walls 15, 16, 17, 18. According to the invention, the displacement of the first part of the individual sluice relative to the second part of the individual sluice takes place respectively along the strip material, i.e. in or contrary to the transportation direction of the strip material, so that the latter, with the movement of the two parts relative to each other, does not have to be removed.

FIG. 4 shows a second example embodiment of the sluice device according to the invention, in which it is not the first individual sluice 11, but rather the second individual sluice 12 which is opened by releasing the connection 32. The first part of the second individual sluice is now formed from the lateral wall 16 and the transportation- and processing rollers 50 which are mounted thereon. Associated with the first part of the second individual sluice is the individual sluice 11, which is mounted securely thereon, in particular with its housing casing 20 and its left-hand lateral wall 15. The second part of the second individual sluice is formed by its housing casing 21 and its right-hand lateral wall 17. Associated with this second part is the third individual sluice 13 with its housing casing 22, its right-hand lateral wall 18 and with the transportation- and/or processing rollers 50 which are fastened on these two walls.

In contrast to the first example embodiment according to FIG. 3, in the second example embodiment, both parts of the second individual sluice with their respectively associated further individual sluices are now movable independently of each other. This is realized in that the displacement device 24 is associated with the first part of the second individual sluice and with the associated first individual sluice 11, whereas the displacement device 25 is associated with the second part of the individual sluice and the associated further individual sluices. In FIG. 4 the two parts of the second individual sluice 12 and their respectively associated further individual sluices are moved by the movement path S with respect to each other along the transportation direction of the strip material 2.

FIG. 5 shows a third example embodiment for the sluice device according to the invention in which, unlike FIG. 4, it is not the second, but rather the third individual sluice 13 which was opened at the connection 33.

FIG. 6 shows a cross-section through one of the individual sluices at the height of the transportation- or processing rollers 50 transversely to the transportation direction of the strip material, which stands perpendicularly on the plane of the drawing. The individual sluice 13 can be seen with its housing casting 22, which is formed here by way of example in a tubular shape. In the interior of the individual sluice 13, the transportation- or processing rollers 50 can be seen, which are arranged above and beneath the strip material 2. These rollers can be driven via connection shafts 53, 54 by a drive 51. Both the individual sluice 13 and also the drive 51 are arranged on a carrier unit 52, being able to be moved by means of the device 25 in or contrary to the transportation direction of the strip.

As an alternative to the illustration in FIG. 6, the drive 51 can also be arranged outside the carrier unit 52; then it is necessary that it is released from the transportation- or processing rollers, before the individual sluice is moved with the device 25.

According to FIG. 6, a pipe connection 55 is joined on the upper side of the housing casing 22. This pipe connection serves, for example, as a suction device for producing an underpressure or a vacuum in the interior of the individual sluice 13. This pipe connection is preferably constructed so that it can be moved together with the individual sluice 13; the pipe connection 55 then does not need to be released from the housing casing 22 when the individual sluice 13 is to be moved. Alternatively however, the connection between the pipe connection 55 and the housing casing 22 can also be constructed so as to be releasable; then, the individual sluice 13 would be movable together with the other parts of the sluice device 10, 10′ possibly associated therewith, independently of the pipe connection 55.

An advantage in the sluice device according to the invention is the possibility of opening the individual sluices and for moving the parts or segments formed by opening, by means of the devices 24, 25 for the displacement thereof. In this way, the interior of the individual sluices and in particular the transportation- or processing rollers which may be situated therein, is accessible for example for maintenance purposes. The opening of the individual sluices does not have to be restricted to a single sluice, but rather can either take place gradually, i.e. successively over time, or else simultaneously with all individual sluices of the sluice device. However, the more individual sluices are opened simultaneously, the more space is required for this.

List of Reference Numbers

2 strip material

3 process area

10 sluice device

10′ sluice device

11 individual sluice

12 individual sluice

13 individual sluice

15 wall

16 wall

17 wall

18 wall

19 wall

20 housing casing

21 housing casing

22 housing casing

24 roller device, device for displacement

25 roller device, device for displacement

41 sluice opening

42 sluice opening

43 sluice opening

44 sluice opening

45 sluice opening

50 transportation- or processing rollers

51 drive

52 carrier unit

53 connection shaft

54 connection shaft

55 pipe connection

1. A sluice device (1, 4, 5, 10) with at least one individual sluice (11) for the passing of strip material,
characterized in that
the individual sluice (11) is formed from at least a first and a second part;
that a releasable connection is provided between the first and the second part for opening and closing the individual sluice; and
that at least one device (24, 25) is provided for displacing the first and the second part of the individual sluice (11) relative to each other in or contrary to the transportation direction of the strip material (21) with an open connection.

2. The sluice device (1, 4, 5, 10) according to claim 1,
characterized in that
the housing of the individual sluice (11) consists of a first lateral wall (16) with a sluice opening (42) for the entry of the strip material (2) into the individual sluice, a second lateral wall (15) with a sluice opening (41) for the exit of the strip material (2) from the individual sluice (11) and a housing casing (20) between the first and the second wall (15).

3. The sluice device (1, 4, 5, 10) according to claim 2,
characterized in that
the first part of the individual sluice (11) has at least a portion of the first lateral wall (16) with the sluice opening (42) for the entry of the strip material (2); and
that the second part of the individual sluice (11) has at least a portion of the second lateral wall (15) with the sluice opening (41) for the exit of the strip material (2).

4. The sluice device (1, 4, 5, 10) according to claim 2
characterized in that
the first or second part of both parts of the individual sluice (11, 12, 113) have at least a portion of the housing casing (20).

5. The sluice device (1, 4, 5, 10) according to claim 2
characterized in that
the individual sluice (11, 12, 13) has processing- or transportation means (50) for the strip material, such as for example processing- or transportation rollers and drives (51) for these means, with the means or the drives being fastened to the first or second lateral wall (15, 16) or to the housing casing (20); and
that these means and drives—preferably corresponding to the lateral wall (15, 16) or to the housing casing (2) to which they are fastened—are associated either with the first or second part of the individual sluice (11, 12, 13) and are able to be displaced therewith.

6. The sluice device (1, 4, 5, 10) according to claim 2
characterized in that
a pipe connection (55) is connected from the exterior onto the housing casing (23) for setting a desired pressure in the interior of the individual sluice (11); and
that the pipe connection (55)—in accordance with the part of the housing casing to which it is connected—is associated either with the first or second part of the individual sluice (11, 12, 13) and is able to be displaced together therewith.

7. The sluice device (1, 4, 5, 10) according to claim 2
characterized in that
a pipe connection (55) is connected releasably from the exterior onto the housing casing (23) fro setting a desired pressure in the interior of the individual sluice; and
that the pipe connection (55), when it is uncoupled from the housing casing (23), is able to be displaced independently from the first or second part of the individual sluice (11, 12, 13) in particular in or contrary to the transportation direction of the strip material (2).

8. The sluice device (1, 4, 5, 10) according to claim 1,
characterized in that
a first device (24) for displacement is provided, for displacing the first part of the individual sluice (11, 12, 13) and a second device (25) for displacement is provided for displacing the second part.

9. The sluice device (1, 4, 5, 10) according to claim 1,
characterized in that
the device (24, 25) for displacement is constructed as a movable undercarriage or as a sliding arrangement.

10. The sluice device (1, 4, 5, 10) in the form of a sluice cascade with a plurality of individual sluices (11, 12, 13) connected in series in the transportation direction of the strip material (2), in which at least one of the individual sluices (11) is constructed in two parts with a first and a second part according to any of the preceding claims, and in which the other individual sluices (12, 13) are connected to the first or second part of the two-part individual sluice (11) and are associated accordingly with the first or second part and are able to be displaced together therewith.

11. The sluice device (1, 4, 5, 10) according to claim 10,
characterized in that
two adjacent individual sluices (11, 12) have a shared lateral wall (16) with a sluice opening (42) for a transition of the strip material (2) from the one individual sluice (12) into the other.

12. A method for opening a sluice device (1, 4, 5, 10 with at least one individual sluice (11) for the passing of strip material characterized by the following steps:
opening the individual sluice (11) by releasing a connection between a first and a second part of the individual sluice; and
displacing the first and the second part of the individual sluice (11) relative to each other in or contrary to the transportation direction of the strip material (2).

13. The method according to claim 12,
characterized in that
the first part of the individual sluices (11) has at least a portion of the first lateral wall (16) with the sluice opening (42) for the entry of the strip material (2); that the second part of the individual sluice (11) has at least a portion of the second lateral wall (15) with the sluice opening (41) for the exit of the strip material (2);’ and that the first and/or the second part of the individual sluice (11, 12, 13), are moved along the strip material (2), whilst the strip material (2) is guided through the sluice openings.

14. The method according to claim 12
characterized in that
the first part and the second part of the individual sluice (11), after maintenance work has been completed, are pushed together again along the strip material (2) and are connected with each other.
